(19) United States
(12) Patent Application Publication
(10) Pub. No.: US 2026/0234880 A1
(43) Pub. Date: Aug. 13, 2026

(54) VAPOR BARRIER SYSTEM

(71) Applicant: Evolution Mechanical Products, LLC, Ridgefield, CT (US)

(72) Inventor: Michael S. Flynn, Ridgefield, CT (US)

(21) Appl. No.: 19/537,082

(22) Filed: Feb. 11, 2026

Related U.S. Application Data
(60) Provisional application No. 63/757,610, filed on Feb. 12, 2025.

(51) Int. Cl. E01F 15/08; B29C 65/50; B32B 27/36

(52) U.S. Cl. CPC E01F 15/08; B29C 65/5042; B32B 27/36

(57) ABSTRACT

A vapor barrier system includes two or more vapor barrier elements, each of which includes a vapor barrier layer, adhesive layer and removable protective layer to selectively cover and uncover the adhesive layer. The vapor barrier layer may have a desired shape and may be combined with other similarly shaped vapor barrier elements or with complementary shapes vapor barrier elements to ensure a seal around the pipe or fitting.

### CROSS-REFERENCE TO RELATED APPLICATIONS

The present application claims benefit of and priority to U.S. Provisional Patent Application Ser. No. 63/757,610 filed Feb. 12, 2025, entitled VAPOR BARRIER SYSTEM, the entire content of which is hereby incorporated by reference herein.

### BACKGROUND

### Field

The present application relates to a vapor barrier system that may be used to provide vapor barrier protection for insulated pipes. In particular, the present application relates to a vapor barrier system including one or more vapor barrier elements including an adhesive that is used to wrap over the insulation on a pipe. The vapor barrier system includes one or more vapor barrier elements, at least one of which has a predetermined shape, for providing coverage on a pipe and includes an adhesive layer that allows for direct application to the insulated pipe.

### Related Art

Construction and renovation of mechanical and plumbing systems in structures often requires installation, replacement or repair of pipes. Such pipes serve various functions including water pipes, heating pipes and HVAC pipes. Below ambient insulated pipes are required to have a vapor barrier to prevent moisture from affecting the insulation, preventing mold and maintaining the integrity of the insulation. Straight pipes may simply be wrapped along their length. Curved portions, fittings, tees, joints and junctions are not easily wrapped given the difference between the inner our outer portions of the circumference thereof.

It would be useful to provide a vapor barrier element that avoids these and other problems.

### SUMMARY

A vapor barrier system in accordance with an embodiment of the present disclosure includes one or more preconfigured vapor barrier elements with preconfigured shapes to adequately cover all portions of an insulated pipe.

A vapor barrier system in accordance with an embodiment of the present application includes: a plurality of vapor barrier elements; each vapor barrier element of the plurality of vapor barrier elements including two narrow ends connected be a widened area and including: a vapor barrier material layer; an adhesive layer provided on a bottom surface of the vapor barrier material later; a protective layer removably attached to the adhesive layer; and an overlap area provided along an edge thereof and along one narrow end, configured to be covered when in use on a pipe fitting; wherein a first vapor barrier element of the plurality of vapor barrier elements is provided on a top portion of a pipe fitting with the widened area covering an outer portion of the pipe and the two narrow ends wrapping around the pipe fitting toward the throat area; a second vapor barrier element of the plurality of vapor barrier elements is provided on a curved portion of the pipe fitting with a second widened area covering an outer portion of the pipe fitting and two second narrow ends wrapping around the pipe toward the throat area such that the second vapor barrier element covers a first overlap area of the first vapor barrier element; a third vapor barrier element of the plurality of vapor barrier elements is provided on a lower portion of the pipe fitting with a third widened area covering an outer portion of the pipe and two third narrow ends wrapping around the pipe toward the throat area such that the third vapor barrier element covers a second overlap area of the second vapor barrier element.

In embodiments, the system includes a fourth vapor barrier element of the plurality of vapor barrier elements provided on a portion of the pipe fitting with a fourth widened area covering an outer portion of the pipe and two fourth narrow ends wrapping around the pipe toward the throat area such that the fourth vapor barrier element covers at least a portion of any of the first barrier element, second barrier element and third barrier element.

In embodiments, the vapor barrier material layer includes a low permeability material.

In embodiments, the vapor barrier material layer includes multiple layers of a low permeability material.

In embodiments, the adhesive layer includes an acrylic adhesive.

In embodiments, the removable protective layer includes paper backer.

In embodiments, the removable protective layer includes a first portion provided on one side of the vapor barrier element and a second portion provided on a second side of the vapor barrier element, with a seam provided between the first portion and the second portion of the vapor barrier element.

A vapor barrier system in accordance with an embodiment of the present disclosure includes: a first vapor barrier element including multiple segments joined together to provide an outer sleeve configured for placement on an outer surface of a pipe fitting; a second vapor barrier element including multiple segments joined together to provide an inner sleeve configured for placement on a throat of the pipe fitting; wherein the first vapor barrier element and second vapor barrier element include: a vapor barrier material layer; an adhesive layer provided on a bottom surface of the vapor barrier material later; and a protective layer removably attached to the adhesive layer; wherein the second vapor barrier element includes an overlap area provided along a lateral edge thereof and configured to be covered when in use on a pipe fitting, and wherein the first barrier element covers the overlap area of the second barrier element when the first barrier element and second barrier element are in place.

In embodiments, the second vapor barrier element includes a first segment positioned at a top of a throat of the pipe fitting, a second segment positioned over the throat of the pipe fitting and overlapping the first segment and a third segment overlapping the second segment and covering a bottom portion of the pipe fitting, and the first vapor barrier element includes a fourth segment positioned opposite the first segment of the second vapor barrier element and covering a top portion of the heel of the pipe fitting, a fifth segment overlapping the fourth segment and opposite and overlapping the second segment and a sixth segment overlapping the fifth segment and opposite and overlapping the third segment.

In embodiments the first barrier element includes a first plurality of different shaped segments joined together and the second barrier element includes a second plurality of different shaped segments joined together.

A vapor barrier system in accordance with another embodiment of the present includes: a first vapor barrier element having an X shape; a second vapor barrier element having an H shape; wherein a longitudinal centerline of the first vapor barrier element covers a throat of a pipe fitting with the legs of the X shape wrapping around the pipe fitting toward a heel of the pipe fitting, and a horizontal centerline of the second vapor barrier element is provided along a centerline of the outer curve with the legs and a remainder of the center wrapping toward the throat of the pipe fitting.

A vapor barrier system in accordance with another embodiment of the present application includes: a first vapor barrier element having a central strip and a plurality of fingers extending away from the central strip; and a second vapor barrier element having a butterfly shape; wherein the first vapor barrier element is provided with the central strip aligned with a centerline of the outer curve of a pipe fitting and the fingers wrapping around the pipe toward a throat, and the second vapor barrier element covers the throat of the pipe fitting with a central portion thereof and the end portions wrapping around the pipe to overlap with the fingers of the first vapor barrier.

In embodiments, the first vapor barrier element and the second vapor barrier element include: a vapor barrier material layer; an adhesive layer provided on a bottom surface of the vapor barrier material later; and a protective layer removably attached to the adhesive layer.

In embodiments, vapor barrier material layer includes a low permeability material.

In embodiments, the vapor barrier material layer includes multiple layers of a low permeability material.

In embodiments, the adhesive layer includes an acrylic adhesive.

In embodiments, the removable protective layer includes paper backer.

In embodiments, the removable protective layer on the first vapor barrier element includes a first portion provided along the central portion that is removed first to secure the first barrier element along the centerline of the out curve of the pipe fitting.

In embodiments, the removable protective layer on the second vapor barrier element includes a first portion covering a narrow portion of the butterfly shape that is removed first and secured to the throat of the pipe fitting, followed by a second portion on one side thereof that is released next and wraps around the pipe and a third portion on another side thereof that is release next and wraps around the pipe.

In embodiments, the removable protective layer includes a first tab connect to the second portion to remove the second portion and a second tab connected to the third portion to remove the third portion.

### BRIEF DESCRIPTION OF THE DRAWINGS

FIG. 1A illustrates an exemplary cross section of a piece of vapor barrier material in accordance with an embodiment of the present disclosure;

FIG. 1B illustrates an exemplary cross section of a vapor barrier element including the vapor barrier material of FIG. 1A in accordance with an embodiment of the present disclosure;

FIG. 2A illustrates an exemplary vapor barrier element in accordance with an embodiment of the present disclosure;

FIG. 2B illustrates the exemplary vapor barrier element of FIG. 2A in combination with other vapor barrier elements covering a bend in an insulated pipe in accordance with an embodiment of the present disclosure;

FIGS. 3A-3D illustrate exemplary positioning of the exemplary vapor barrier element of FIG. 2A with others in accordance with an embodiment of the present disclosure;

FIG. 4A illustrates an exemplary arrangement of a first portion of a vaper barrier system suitable for covering a bend in an insulated pipe in accordance with an embodiment of the present disclosure;

FIG. 4B illustrates an exemplary arrangement of a second portion of a vapor barrier system suitable for covering a bend in an insulated pipe in accordance with an embodiment of the present disclosure;

FIGS. 5A-5C illustrate exemplary arrangements of the first portion and the second portion of the vapor barrier system covering a bend in an insulated pipe in accordance with an embodiment of the present disclosure;

FIGS. 6A and 6B illustrate exemplary vapor barrier elements that may be combined to cover an insulated pipe in accordance with an embodiment of the present disclosure;

FIGS. 7A and 7B illustrate exemplary vapor barrier elements that may be combined to cover an insulated pipe in accordance with an embodiment of the present disclosure;

FIGS. 8A and 8B illustrate exemplary positioning of the vapor barrier elements of FIGS. 7A and 7B to cover an insulated pipe in accordance with an embodiment of the present disclosure;

FIGS. 9A and 9B illustrate exemplary vapor barrier elements that may be combined to cover an insulated pipe in accordance with an embodiment of the present disclosure; and

FIG. 10 illustrates an exemplary vapor barrier element that may cover an insulated pipe bend in accordance with an embodiment of the present disclosure.

### DESCRIPTION OF THE EMBODIMENTS

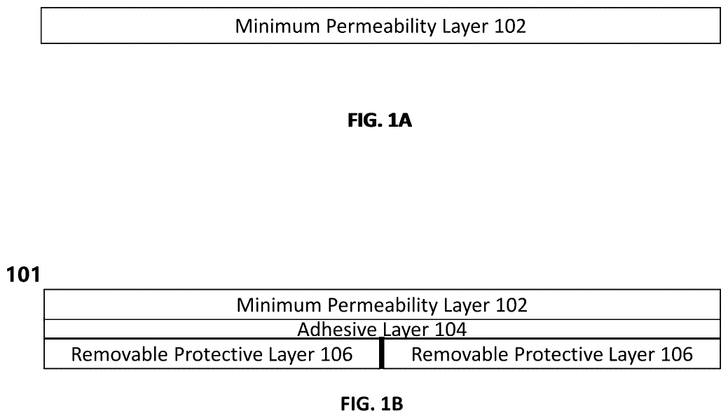

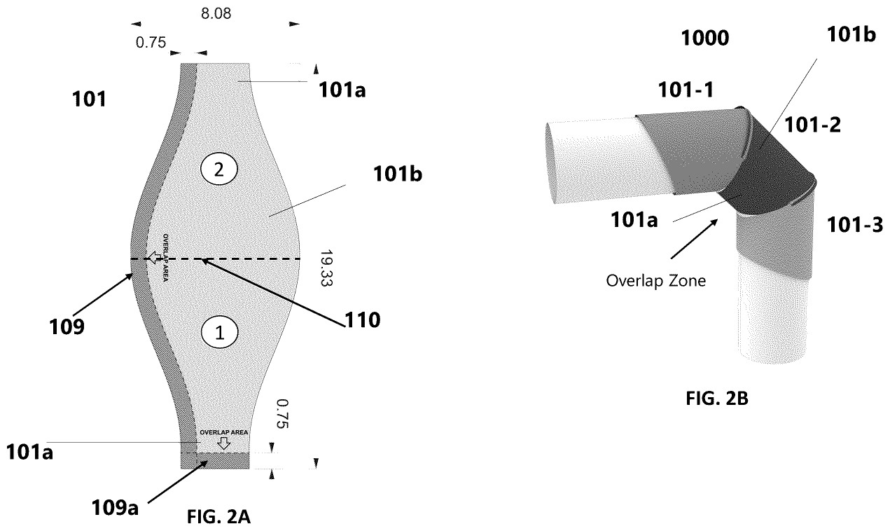

FIG. 1A illustrates a cross-section of a layer of vapor barrier material 102 suitable for use in a vapor barrier system 10000 (See FIG. 2B, for example) in accordance with an embodiment of the present disclosure. In embodiments, the vapor barrier material 102 has a low permeability. In embodiments, the vapor barrier material 102 may include multiple layers. In embodiments, the vapor barrier material 102 may include a layer of white polyester film, an aluminum layer and a clear polyester layer. In embodiments, the white layer may be clear or another color. In embodiments, the clear layer may be white or another color. In embodiments, the aluminum layer may be or may include another metal. An exemplary list of ingredients for the vapor barrier material 102 is provided below.

| Ingredient | Percent | CAS# |
|---|---|---|
| Aluminum Foil | 50-70% | 7429-90-5 |
| Polyester | 20-40% | Proprietary |
| Antimony Trioxide* | <1% | 1309-64-4 |

*Antimony Trioxide is inextricably bound within the polymer matrix of this product and not considered a hazardous chemical under OSHA Standard (29 CFR. 1910, 1200) per (b)(2).
The specific identity and/or exact percentages of composition has been withheld as trade secret.

In FIG. 1B, a vapor barrier element 101 suitable for use in a vapor barrier system 1000 of the present application may include the vapor barrier material layer 102 with an adhesive layer 104 provided on one side thereof. In embodiments, a removable protective layer 106 covers the adhesive layer 104 until the element 101 is ready for application to an insulated pipe. In embodiments, the vapor barrier layer 102 may be or may include the vapor barrier material 102 discussed above. In embodiments, any suitable vapor barrier material may be used. In embodiments, the adhesive layer 104 may be, or may include, an acrylic adhesive layer, however any suitable adhesive may be used. In embodiments, the protective layer 106 may be or may include backer paper. In embodiments, the protective layer 106 may include one or more seams, perforated portions or cuts 108 such that the protective layer 106 may be removed in sections to expose the adhesive layer 104.

In embodiments, the vapor barrier element 101 (see FIGS. 1B, 2A) may be cut into various shapes to allow for application to insulate pipe fittings, joints and bends. In embodiments, the protective layer 106 may be removed in specific patterns to expose the adhesive layer 104 such that the barrier element 101 can be applied to the insulated pipe fitting, joint or bend. In embodiments, the application of the barrier element 101 to an insulated pipe portion or junctions provides for self-sealing without the need for additional tape or film.

FIG. 2A illustrates an exemplary vapor barrier element 101. In FIG. 2B, three such barrier elements 101-1, 101-2, 101-3 form a barrier system 1000 and are applied to a pipe fitting to cover the bend. The vapor barrier element 101 illustrated in FIG. 2A has a shape configured for application to any angled insulated pipe, whether a 45 degree angle is used or a 90 degree angle is used. As indicated in FIG. 2B, multiple barrier elements 101 may be applied to the insulated pipe to provide full coverage around the bend or joint. In embodiments, an overlap area 109 is provided on the barrier 101-1, for example, which, in use, overlaps with an adjacent barrier element to ensure full coverage. In FIG. 2A, the overlap area 109 is the minimum area of overlap with an adjacent barrier element 101 to ensure self-sealing between the barrier elements. In embodiments, the overlap area 109 may have a different color, pattern or other visible difference when compared to the rest of the barrier element 101. In embodiments, once the barrier elements 101 are applied, visual inspection is simplified by the contrasting visual appearance of the overlap area 109 to ensure self-sealing. In embodiments, if any of the overlap area 109 is visible, then the barrier elements 101 are not sufficiently overlapped to ensure self-sealing.

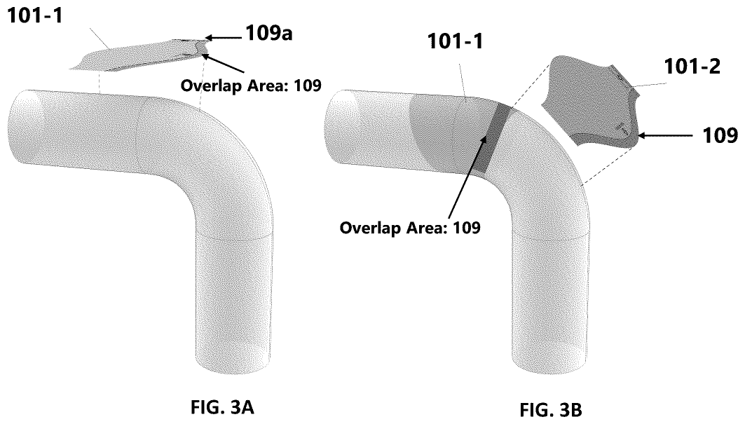

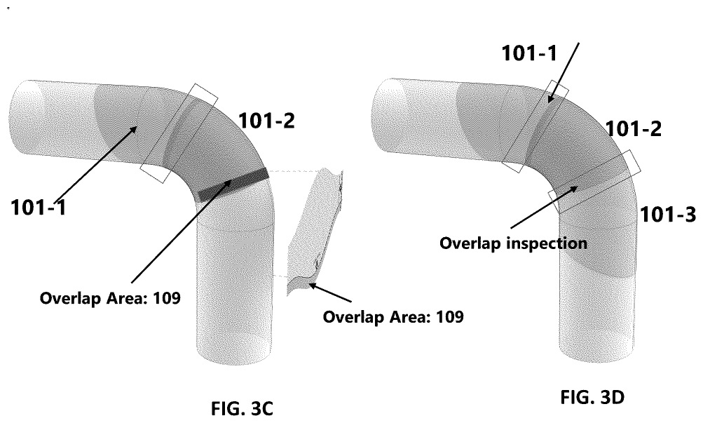

In embodiments, section 1 of the protective layer 106 may be removed at the seam or cut line 110 and a portion of the barrier element 101-1 may be adhered to the pipe, with the narrow portion 101a at the throat of the pipe fitting as is generally indicated in FIG. 3A. In embodiments, the second side 2 of the protective layer 106 may be removed and the other side of the element 101a wraps around the pipe such that the wide portion 101b covers the outer circumference of the pipe fitting and the overlap portion 109a at the end is overlapped by the opposite end 101a. In embodiments, a second barrier element 101-2 is similarly provided adjacent the first with the overlap portion 109 of the first barrier 101-1 covered by the second barrier element 101-2 as indicated in FIG. 3B. In embodiments, a third barrier element 101-3 is applied adjacent the second barrier element covering the overlap area 109 of the second barrier element as indicated in FIG. 3C. If additional barrier elements 101 are needed, they should be added until the entire junction is covered. Visual inspection should reveal whether all overlap areas 109 have been covered, ensuring a seal. If an overlap area 109 is visible after installation of the adjacent elements 101, a supplemental barrier element may be provided over the two panels to ensure the full overlap is covered to achieve the vapor barrier integrity. In embodiments, as can be seen in FIG. 3D, there should be no visible overlap areas between the barrier elements 101-1, 101-2, 101-3.

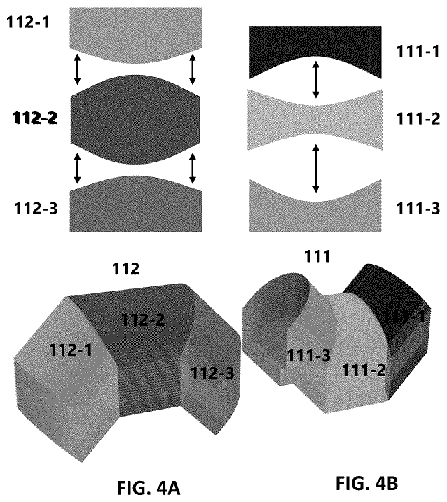

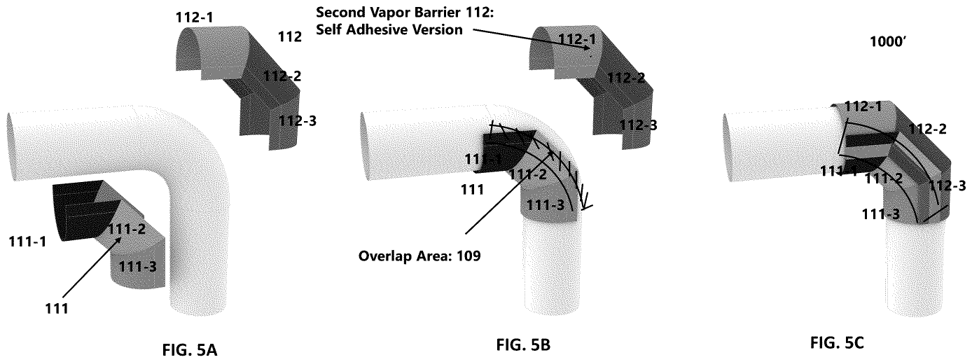

In embodiments, vapor barrier element 101 may be provided as a two-part assembly to form a system 1000′ (FIG. 5C) that covers the entire junction. In embodiments, a first part 111 may include different shapes that are preconfigured and connected to each other as indicated in FIG. 4B to form an inner sleeve. In embodiments, the second part 112 may include different shapes that are preconfigured and connected to each other as indicated in FIG. 4A to form an outer sleeve. In embodiments, the inner sleeve 111 and outer sleeve 112 are provided as a set and are installed on the inner portion and outer portion of the junction, respectively. In embodiments, the two parts 111, 112 may be prefabricated and sized to accommodate specific pipes. In embodiments, the two parts 111, 112 include a removable protective layer that covers adhesive that allows them to be adhered directly to the insulated pipe junction. In embodiments, the protective layer 106 may be removed from the first part 111 and the first part may be placed on the pipe, preferably starting at the throat of the pipe fitting and working up as indicated in FIG. 5A. In embodiments, this inner sleeve part 111 may include an overlap area 109 at its edge similar to that discussed above to indicate the minimum amount of overlap needed to provide a seal as is generally illustrated in FIG. 5B. In embodiments, the protective layer 106 may be removed from the outer sleeve part 112 and the second part may be attached to the top of the joint. In embodiments, the second part 112 is attached starting at the center of the pipe and then worked work down on the left and right sides. In embodiments, the second part 112 is attached to ensure that on both the right and left sides the second part 112 fully covers the overlap area 109 on the first part 111 such as in FIG. 5C. In embodiments, a visual inspection may be performed on both sides to ensure that the overlap area is not exposed.

In embodiments, the inner sleeve 111 may be constructed on the pipe fitting starting with a first segment 111-1 provided at a top of the throat of the pipe, followed by the second segment 111-2 which overlaps the first segment 111-1 and covers the throat and then the third segment 111-3, which overlaps the second segment 111-2. In embodiments, the outer sleeve 112 may be made of a fourth segment 112-1 that may be attached to a top portion of the outer circumference of the fitting opposite and overlapping the first segment 111-2 followed by a fifth segment 112-2 overlapping the fourth segment 112-1 and opposite and overlapping the second segment 111-2 followed by a sixth segment overlapping the fifth segment 112-2 and opposite and overlapping the third segment 111-3. The use of multiple segments allows the three-dimensional shape of the fitting to be fully covered.

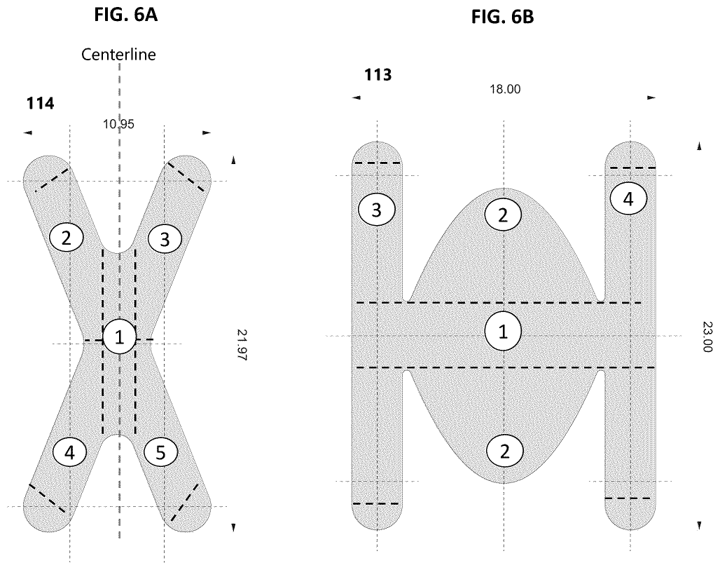

FIG. 6B illustrates an exemplary vapor barrier element 113 suitable for attachment to a top of a pipe or fitting that has a general H shape with a widened horizontal cross portion. FIG. 6A illustrates an exemplary vapor barrier element 114 suitable for attachment to a bottom of a pipe fitting in the throat area thereof and having a general X shape. In embodiments, the vapor barrier elements 113, 114 may be provided together as a system to be mounted on top and bottom of a 45 degree or 90 degree pipe joint or fitting. In embodiments, a spline cut may be provided along centerline of the barrier elements to allow for easy placement on the center of the fitting or pipe. Each of the barriers 113, 114 may include protective layers divided into sections as indicated in FIGS. 6A and 6B. In use, section 1 of the protective layer 106 on barrier element 113 may be removed and applied around the spine of the top (outer curve) of the fitting. The section 2 and 3 may then be removed and wrapped around toward the throat of the fitting. Sections 4 and 5 may be removed and fold down and around the pipe. In embodiments, the first section of the barrier element 114 is removed and folds along the centerline and is placed at the throat of the pipe fitting. Sections 2-5 of the barrier element 114 may be removed sequentially and are placed around the pipe fitting from bottom to top (inside curve to outside curve, or throat to heel). In embodiments, the barrier elements 113, 114 may be smoothed out to ensure that the pipe joint is completely wrapped.

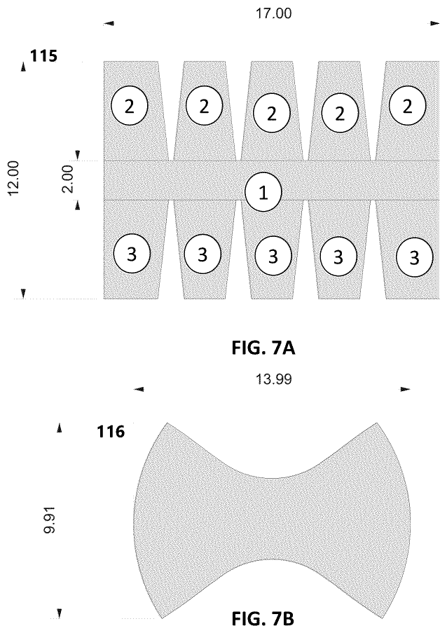

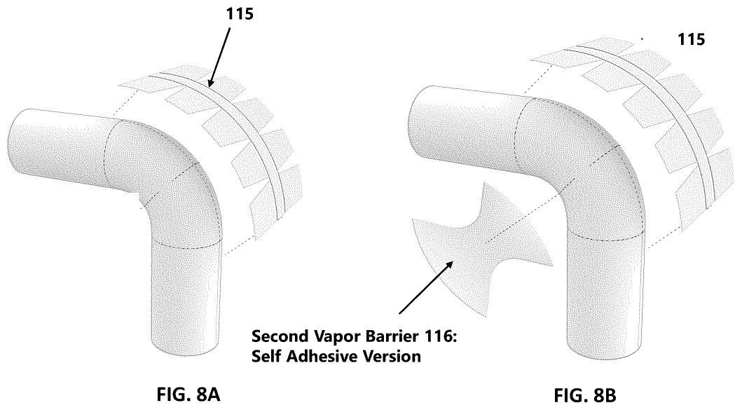

In embodiments, FIG. 7A illustrates another vapor barrier element 115 that may be attached to the top of the pipe or fitting as in FIG. 8A while the vapor barrier element 116 is attached to the bottom of the pipe fitting around the throat area as indicate in FIG. 7B. The elements 115 and 116 together form a barrier system. In embodiments, the barrier element 115, 116 may be packaged together and installed on the top and bottom of a 90 degree or 45 degree pipe joint or fitting. In embodiments, a center spline cut may be provided in barrier element 115 and allows for easy placement on the center of the pipe fitting as indicated in FIG. 8A such that the fingers wrap around the pipe. In embodiments, the barrier 116 attaches around the throat of the pipe fitting and overlaps the barrier element 115 as indicated in FIG. 8B. Thus, the two barriers 115, 116 surround the joint of the pipe.

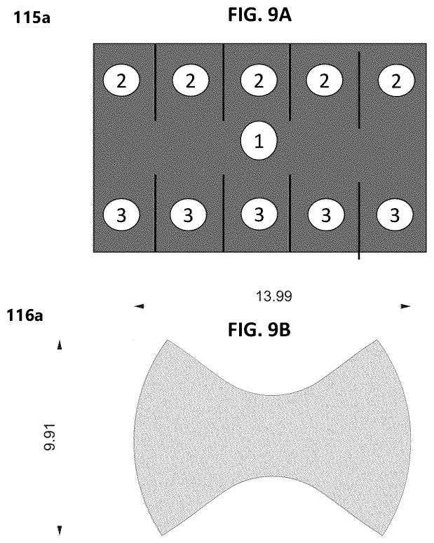

In embodiments, another vapor barrier element 115a is illustrated in FIG. 9A which cooperates with vapor barrier element 116a to seal around a pipe joint or fitting. In embodiments, the vapor barrier element 115a may be attached to the top of the pipe or fitting and the vapor barrier element 116a may be attached to the bottom of the pipe fitting, around the throat area. In embodiments, the barriers 115a, 116a may be shipped or sold as a set to be installed over a 900 or 450 pipe joint or fitting. In embodiments, the barrier element 115a may include a center spline cut that allows for easy placement on the center of the pipe fitting, similar to the cut discussed above with respect to barrier element 115. In embodiments, the lower barrier element 116a overlaps the edges 2, 3 of the barrier element 115a to ensure a good seal. In embodiments, in operation, the protective layer 106 is removed from the barrier element 115a and the element is placed down the center of the pipe fitting while the edges 2, 3 are folded down towards the throat of the fitting. In embodiments, the protective layer may be removed from the barrier element 116a and the barrier element may be placed on the throat of the fitting and folded up to overlap all of the sections from panel 115a.

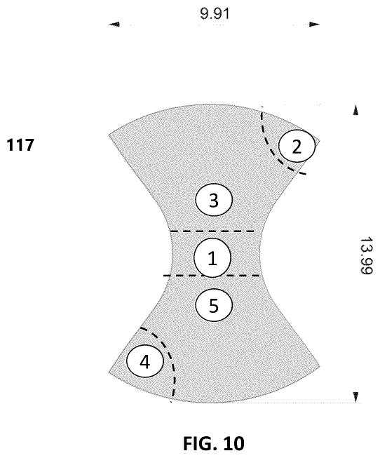

In embodiments, a vapor barrier element 117 is shown in FIG. 10. In embodiments, the barrier element 117 may be similar in construction to the barrier element 116 discussed above. In embodiments, the vapor barrier element 117 may include a protective layer (like layer 106, for example) to cover the adhesive layer (like layer 104, for example). In embodiments, the barrier element 117 fully wraps the pipe joint and seals on itself to form a desired vapor barrier. In embodiments, 4 section whisper cuts are provided to improve the ability to handle and place the barrier element in an optimum location. Corner tabs 2 may be provided to facilitate removal of the protective layer.

In use, section 1 of the protective layer 106 may be removed and the barrier element 117 may be placed at the throat of the pipe fitting. Then, in embodiments, the tabs 2 and 4 may be used to remove panels 3 and 5 one at a time to reveal the adhesive layer while the barrier element 117 is folded onto the top of the fitting or pipe. In embodiments, one side of the barrier element 117 is folded up and overlaps with the other side along the top of the pipe ensuring that all seams are covered. The barrier element 117 may be smoothed over as needed to ensure adhesion to the insulated pipe.

The dimensions illustrated in the figures are exemplary and the sizes of the various barriers may be varied to accommodate pipes of different sizes. In embodiments, all barriers discussed herein may be smoother over after application to secure them in place.

Now that embodiments of the present invention have been shown and described in detail, various modifications and improvements thereon can become readily apparent to those skilled in the art. Accordingly, the exemplary embodiments of the present invention, as set forth above, are intended to be illustrative, not limiting. The spirit and scope of the present invention is to be construed broadly.

What is claimed is:

1. A vapor barrier system comprising:
a plurality of vapor barrier elements;
each vapor barrier element of the plurality of vapor barrier elements including two narrow ends connected be a widened area and including:
a vapor barrier material layer;
an adhesive layer provided on a bottom surface of the vapor barrier material later;
a protective layer removably attached to the adhesive layer; and
an overlap area provided along an edge thereof and along one narrow end, configured to be covered when in use on a pipe fitting;
wherein a first vapor barrier element of the plurality of vapor barrier elements is provided on a top portion of a pipe fitting with the widened area covering an outer portion of the pipe and the two narrow ends wrapping around the pipe fitting toward the throat area;
a second vapor barrier element of the plurality of vapor barrier elements is provided on a curved portion of the pipe fitting with a second widened area covering an outer portion of the pipe fitting and two second narrow ends wrapping around the pipe toward the throat area such that the second vapor barrier element covers a first overlap area of the first vapor barrier element;
a third vapor barrier element of the plurality of vapor barrier elements is provided on a lower portion of the pipe fitting with a third widened area covering an outer portion of the pipe and two third narrow ends wrapping around the pipe toward the throat area such that the third vapor barrier element covers a second overlap area of the second vapor barrier element.

2. The vapor barrier system of claim 1, further comprising a fourth vapor barrier element of the plurality of vapor barrier elements provided on a portion of the pipe fitting with a fourth widened area covering an outer portion of the pipe and two fourth narrow ends wrapping around the pipe toward the throat area such that the fourth vapor barrier element covers at least a portion of any of the first barrier element, second barrier element and third barrier element.

3. The vapor barrier system of claim 1, wherein the vapor barrier material layer includes a low permeability material.

4. The vapor barrier system of claim 1, wherein the vapor barrier material layer includes multiple layers of a low permeability material.

5. The vapor barrier system of claim 1, wherein the adhesive layer includes an acrylic adhesive.

6. The vapor barrier system of claim 1, wherein the removable protective layer includes paper backer.

7. The vapor barrier system of claim 6, wherein the removable protective layer includes a first portion provided on one side of the vapor barrier element and a second portion provided on a second side of the vapor barrier element, with a seam provided between the first portion and the second portion of the vapor barrier element.

8. A vapor barrier system comprising:
a first vapor barrier element including multiple segments joined together to provide an outer sleeve configured for placement on an outer surface of a pipe fitting;
a second vapor barrier element including multiple segments joined together to provide an inner sleeve configured for placement on a throat of the pipe fitting;
wherein the first vapor barrier element and second vapor barrier element include:
a vapor barrier material layer;
an adhesive layer provided on a bottom surface of the vapor barrier material later; and
a protective layer removably attached to the adhesive layer;
wherein the second vapor barrier element includes an overlap area provided along a lateral edge thereof and configured to be covered when in use on a pipe fitting, and
wherein the first barrier element covers the overlap area of the second barrier element when the first barrier element and second barrier element are in place.

9. The vapor barrier system of claim 8, wherein the second vapor barrier element includes a first segment positioned at a top of a throat of the pipe fitting, a second segment positioned over the throat of the pipe fitting and overlapping the first segment and a third segment overlapping the second segment and covering a bottom portion of the pipe fitting, and the first vapor barrier element includes a fourth segment positioned opposite the first segment of the second vapor barrier element and covering a top portion of the heel of the pipe fitting, a fifth segment overlapping the fourth segment and opposite and overlapping the second segment and a sixth segment overlapping the fifth segment and opposite and overlapping the third segment.

10. The vapor barrier system of claim 8, wherein the first barrier element includes a first plurality of different shaped segments joined together and the second barrier element includes a second plurality of different shaped segments joined together.

11. A vapor barrier system comprising:
a first vapor barrier element having an X shape;
a second vapor barrier element having an H shape;
wherein a longitudinal centerline of the first vapor barrier element covers a throat of a pipe fitting with the legs of the X shape wrapping around the pipe fitting toward a heel of the pipe fitting, and
a horizontal centerline of the second vapor barrier element is provided along a centerline of the outer curve with the legs and a remainder of the center wrapping toward the throat of the pipe fitting.

12. A vapor barrier system comprising:
a first vapor barrier element having a central strip and a plurality of fingers extending away from the central strip; and
a second vapor barrier element having a butterfly shape;
wherein the first vapor barrier element is provided with the central strip aligned with a centerline of the outer curve of a pipe fitting and the fingers wrapping around the pipe toward a throat, and
the second vapor barrier element covers the throat of the pipe fitting with a central portion thereof and the end portions wrapping around the pipe to overlap with the fingers of the first vapor barrier.

13. The vapor barrier system of claim 12, wherein the first vapor barrier element and the second vapor barrier element include:
a vapor barrier material layer;
an adhesive layer provided on a bottom surface of the vapor barrier material later; and
a protective layer removably attached to the adhesive layer.

14. The vapor barrier system of claim 13, wherein the vapor barrier material layer includes a low permeability material.

15. The vapor barrier system of claim 13, wherein the vapor barrier material layer includes multiple layers of a low permeability material.

16. The vapor barrier system of claim 13, wherein the adhesive layer includes an acrylic adhesive.

17. The vapor barrier system of claim 13, wherein the removable protective layer includes paper backer.

18. The vapor barrier system of claim 13, wherein the removable protective layer on the first vapor barrier element includes a first portion provided along the central portion that is removed first to secure the first barrier element along the centerline of the out curve of the pipe fitting.

19. The vapor barrier system of claim 13, wherein the removable protective layer on the second vapor barrier element includes a first portion covering a narrow portion of the butterfly shape that is removed first and secured to the throat of the pipe fitting, followed by a second portion on one side thereof that is released next and wraps around the pipe and a third portion on another side thereof that is release next and wraps around the pipe.

20. The vapor barrier system of claim 19, wherein the removable protective layer includes a first tab connect to the second portion to remove the second portion and a second tab connected to the third portion to remove the third portion.
